(19) United States
(12) Patent Application Publication
(10) Pub. No.: US 2008/0172170 A1
(43) Pub. Date: Jul. 17, 2008

(54) Method Of Controlling A Rotating Electrical Machine

(75) Inventors: Brice Lecole, Paris (FR); Magali Laurence, Paris (FR)

Correspondence Address: MATTHEW R. JENKINS, ESQ., 2310 FAR HILLS BUILDING, DAYTON, OH, 45419, US

(73) Assignee: VALEO EQUIPEMENTS ELECTRIQUES MOTEUR, CRETEIL-CEDEX (FR)

(21) Appl. No.: 11/575,774

(22) PCT Filed: Sep. 22, 2005
(86) PCT No.: PCT/FR05/02352

§ 371 Date: Oct. 17, 2007

(30) Foreign Application Priority Data
Sep. 23, 2004 (FR) 0410096

(51) Int. Cl. G06F 19/00

(52) U.S. Cl. 701/113

(57) ABSTRACT

A method of controlling a rotating electrical machine for a motor vehicle, whereby the machine is intended to operate in starter mode in order to start a heat engine of the vehicle. The inventive method is characterized in that it comprises the following steps consisting in: testing conditions known as the safe conditions before and during any start-up phase, and testing conditions known as the pre-start-up conditions before the start-up phase. According to the invention, in the event of a negative safe conditions test, the execution of the start-up phase is blocked or interrupted at any moment, while, in the event of a negative pre-start-up conditions test, the execution of the start-up phase is blocked. The invention is suitable for the alternator-starter of a motor vehicle.

### FIELD OF THE INVENTION

The present invention concerns a method of controlling a rotary electrical machine for a motor vehicle, the said machine being intended to function in starter mode for starting a thermal engine of the said vehicle. It also concerns a device for implementing such a control method.

### PRIOR ART

The control method makes it possible to implement, for the thermal engine, functioning with automatic cutoff and starting (including restarting) of the thermal engine, a function known by the English term “Stop and Go”. To this end, the control method controls the rotary electrical machine in order to automatically start the thermal engine after a stoppage of the thermal engine, the said machine then functioning in starter mode.

Such an electrical machine is coupled to the said thermal engine, by means of a belt for example, and in general comprises a stator and a rotor. A current applied to the stator of the machine causes the rotor to start to rotate, which then drives the shaft of the thermal engine.

A typical situation of functioning in “Stop and Go” mode is that of stopping at a red light. When the vehicle stops at the light, the thermal engine is automatically stopped and then, when the light changes to green, the engine is restarted in particular by means of the electrical machine following the detection of the pressing of the clutch pedal by the driver, this action being interpreted as a request to restart. The advantage of this functioning in “Stop and Go” mode will thus be understood in terms of energy savings and reduction in pollution, in particular in an urban environment.

However, this circumstance of implementation of functioning in “Stop and Go” mode remains very particular and does not cover all situations where restarting may be sought.

### OBJECT OF THE INVENTION

Thus a technical problem to be resolved by the object of the present invention is to propose a method of controlling a rotary electrical machine for a motor vehicle, the said machine being intended to function in starter mode for starting a thermal engine of the said vehicle, which makes it possible to define the conditions in which an instruction to start the thermal engine of the vehicle, initially stopped, is transmitted to the rotary electrical machine.

A solution to the technical problem posed consists, according to a first object of the present invention, of the control method comprising the steps of:
testing so-called safety conditions before and during any starting phase, and
testing so-called conditions prior to starting before the starting phase.

Thus the invention provides for two major categories of starting conditions, namely the said essential safety conditions that must be satisfied continuously at any time since they usually relate to reasons of safety of the vehicle, the driver or other persons, and the said conditions prior to starting that are satisfied only at the time of the starting request so as to ensure that nothing opposes the starting of the thermal engine.

According to non-limiting preferential embodiments, the present invention also has the following characteristics.
The rotary electrical machine is intended to function in generator mode in order to supply an on-board system of the said motor vehicle. Thus the control method makes it possible to control a reversible machine such as an alternator/starter, such an alternator/starter thus combining the conventional function of alternator in which the shaft of the thermal engine of the vehicle drives the rotor of the machine so as to produce an electric current in the stator, and the starting function.
The control method also comprises the additional steps of:

in the case of a negative test on the safety conditions, preventing or interrupting at any time an execution of the said starting phase, and

in the case of a negative test on the prior conditions, preventing execution of the starting phase.

Thus, even if the starting phase has begun, it is possible to stop it if a problem arises.
The prior conditions are no longer satisfied after the starting instruction given following a starting request, the invention even providing, in the case of a positive test, that the said conditions prior to starting are kept valid for a given period of validity. Thus this artifice makes it possible for example to make several starting attempts even if a prior condition is no longer satisfied.
However, in the case of loss of validity of the conditions prior to starting, the starting phase is interrupted. This affords a more flexible management of the prior conditions. Thus, for example, it is possible to act on the given period of validity so that a given number only of attempts can be made.

Moreover, the invention distinguishes two different types of starting: the first startups, that is to say conventional startups that can be made with the engine cold, and restarts, that is to say after a stop phase, at a red light for example.

The aim of the invention is therefore to define, according to the type of starting requested, the safety and prior conditions that must be satisfied and the way in which these conditions are managed by the control method according to the invention.

Thus, according to non-limiting preferential embodiments, the invention also comprises the following characteristics:
When the starting is a first starting, a safety condition is a minimum period separating two consecutive starting instructions. Thus this makes it possible to limit the risks of overheating of the machine or of the machine electronics.
When the starting is a first starting, a condition prior to the starting is a minimum duration of an action on an ignition key of the vehicle. Thus this makes it possible to be sure that the driver is requesting starting.
When the starting is a restarting, the said safety conditions are, taken separately or in combination, a minimum time between two consecutive restarting instructions and a closed position of the vehicle bonnet. Thus this makes it possible to limit the risks of overheating of the machine or of the machine electronics. In addition, restarting does not take place if the bonnet is open since this could be dangerous for the user.
Moreover, provision is made for invalidating the said safety condition of closed position of the vehicle bonnet in the case of an action on the ignition key of the vehicle. Thus this thus enables the user of the vehicle, if he so wishes, to check his engine when it is rotating.

The invention also distinguishes two types of action for triggering a starting. One type of action coming from the vehicle driver, whether intentional or not, and one type of action not coming from the driver.
Thus, according to a first non-limiting embodiment, when the starting is a restarting, the said prior starting conditions are determined by at least one intentional action of the vehicle driver.
The said intentional action is an action on an ignition of the vehicle for a given minimum time, an action on a means of activation/deactivation of the starting control by the electrical machine, an action on a clutch pedal of the vehicle or an action on an accelerator pedal of the vehicle.
According to a second non-limiting embodiment, when the starting is a restarting, the said prior starting conditions are determined by at least one unintentional action of the vehicle driver.
The said unintentional action is an opening of the driver's door.
According to a third non-limiting embodiment, when the starting is a restarting, the said prior starting conditions are determined without an action of the driver.
The said prior conditions are, taken separately or in combination, a detection of a speed of the vehicle greater than a given value, a restart request coming from a vehicle battery monitoring system, a restart request that is a function of a vehicle air-conditioning system, and a restart request that is a function of a vehicle braking system.

The invention also provides for a starting as a function of the air-conditioning system.
Provision is made for sending a request to restart the thermal engine if the air-conditioning system is started up during a stop phase of the thermal engine, when it was switched off on stopping. Thus this makes it possible to start up the air-conditioning system immediately according to the wish of the driver.
In additional, provision is made for preventing the sending of a request to restart the thermal engine for a given period if the air-conditioning system was running when the thermal engine was stopped. Thus this avoids having a stopping and switching on of the air-conditioning system that are too close if the temperature increases very quickly, causing a nuisance for the driver.
Moreover, in order to restart the air conditioning, a request to restart the thermal engine is sent at the end of a given stop period. Thus this enables the driver to obtain air conditioning even if the cabin temperature has not increased.

In addition the invention takes account of various embodiments of the air-conditioning system depending on whether it comprises a certain type of sensor.
When the air-conditioning system comprises an air temperature sensor at the discharge from an evaporator of the air-conditioning system, a request to restart the thermal engine is sent if the temperature of the air blown out is above a given value.
When the air-conditioning system comprises a vehicle cabin sensor, a request to restart the thermal engine is sent if the temperature in the vehicle cabin increases by a given value after a stoppage of the thermal engine.

In addition, the invention also concerns the execution of the starting instructions, and more especially the restartings of the thermal engine requested of the electrical machine.

In particular, provision is made by the invention for a restart instruction not to be executed if the thermal engine is already started. This arrangement has the advantage of preventing restarting of the electrical machine when the thermal engine has previously been started by another means. In this case, the said reversible machine is put in alternator mode, without passing through a starting phase. This situation applies in particular when the electrical machine is an alternator/starter and the other means is an additional conventional starter.

Finally, according to a preferred non-limiting embodiment of the invention, the control method comprises the additional steps of:
counting start instructions by means of a counter,
incrementing the said counter by one unit at each start instruction up to a maximum value beyond which any start instruction is inhibited,
and decrementing the said counter by one unit per given interval of time.

In addition, provision is made for two consecutive starting instructions to be separated by a given interval of time. Thus there is obtained in this way optimum management of successive restarts preventing any risk of overheating of the alternator/starter and electronic circuits.

In addition, the starting instruction is transmitted to the rotary electrical machine when the counter is below the excluded maximum value, and the starting instruction is transmitted to an additional starter when the counter has reached the maximum value. Thus in this way any risk of overheating is avoided. In addition, the starting of the rotary electrical machine is avoided if optimum conditions are not achieved or if the said machine has a problem.

According to a second object of the invention, the invention proposes a reversible rotary electrical machine comprising a device for implementing the control method according to any one of the above characteristics.

According to a third object of the invention, the invention proposes a device for controlling a rotary electrical machine for a motor vehicle, the said machine being intended to function in starter mode for starting a thermal engine of the said vehicle, characterised in that it comprises:
first means for testing so-called safety conditions, before and during any starting phase, and
second means for testing so-called prior-to-starting conditions, before the said starting phase.

According to the said device, the first means are also suitable for preventing and interrupting at any time execution of the said starting phase in the case of a negative test of the safety conditions and the second means are also able to prevent execution of the starting phase in the case of a negative test of the prior conditions.

The description that follows with regard to the accompanying drawings, given by way of non-limiting examples, will give a good understanding of what the invention consists and how it can be implemented.

### BRIEF DESCRIPTION OF THE FIGURES

FIG. 1 is a diagram illustrating a motor vehicle in which the control method according to the invention is implemented.

FIG. 2 is a diagram illustrating the management of the safety and prior conditions by the control method according to the invention.

FIG. 3a is a timing diagram of the state of a prior condition of FIG. 2 in the case of a short-validity period.

FIG. 3b is a timing diagram of the state of a prior condition of FIG. 2 in the case of a long-validity period.

FIGS. 4 and 5 are respectively a diagram and a timing diagram illustrating the management of prior conditions of FIG. 2 relating to the air conditioning of the vehicle.

FIG. 6 is a diagram of the operating phases of an alternator/starter of a vehicle comprising the control method according to the invention.

FIG. 7 is a timing diagram illustrating a sequence of successive starting instructions as organised by the control method according to the invention.

### DETAILED DESCRIPTION OF PREFERENTIAL EMBODIMENTS OF THE INVENTION

In the following description, the control method according to the invention is applied to a rotary electrical machine of a vehicle such as an alternator/starter. Naturally the control method can be applied to any other rotary electrical machine such as a conventional starter.

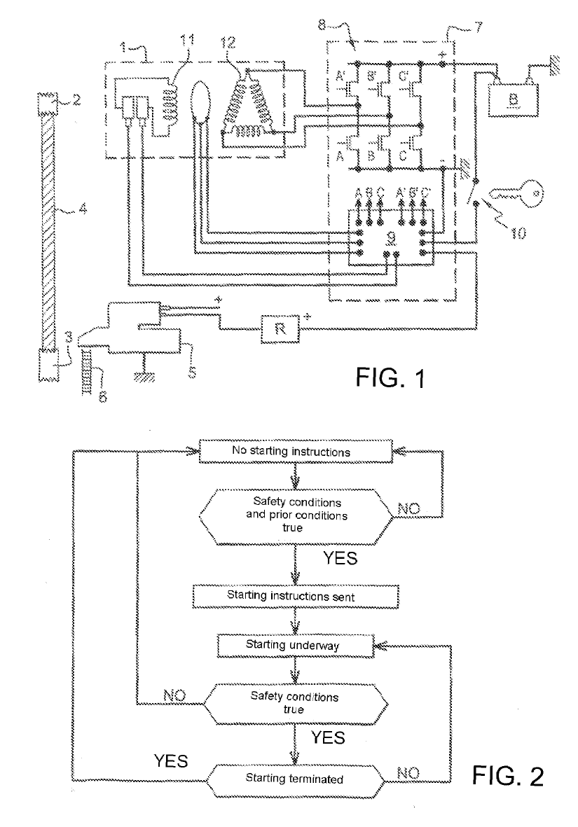

In FIG. 1, a vehicle comprises:
a thermal engine (not shown),
a separate alternator/starter 1 comprising a rotor 11, a stator 12 and a shaft terminating in a pulley 2 that is connected to a pulley 3 of the thermal engine crankshaft by means of a belt 4. This alternator/starter is mounted in the place that the alternator normally takes. This alternator/starter is mounted in the place that the alternator normally takes. In general terms, a reversible rotary electrical machine such as an alternator/starter combines two distinct functions, namely on the one hand the conventional function of alternator when the shaft of the thermal engine drives the rotor 11 of the machine so as to produce an electric current at the stator, and on the other hand the function of starter when conversely a current applied to the stator of the machine causes the rotor to rotate which then drives the shaft of the thermal engine in a similar manner to a conventional starter,
optionally, an additional conventional starter 5 whose pinion is able to mesh with the teeth on a ring 6 for driving the shaft of the thermal engine, and
control electronics 7 for controlling the alternator/starter.

The control electronics 7 comprise:
a transistor bridge 8 that is a reversible power converter and that provides control in starter mode and synchronous rectification in alternator mode;
a management unit 9 that controls the various transistors of the converter 8 and in particular manages the various following functions:

power in starter and alternator modes

regulation in alternator mode

transition from starter mode to alternator mode.

The management unit 9 is for this purpose supplied by the voltage of the battery, referenced B, to which it is connected by means of a vehicle ignition switch 10.

It should be noted that, according to a non-limiting preferential embodiment, the starting strategy according to the control method is downloaded into a flash or EEPROM memory of a control device such as a microcontroller of the alternator/starter. The microcontroller is situated in the management unit 9 of the alternator/starter and communicates with a bus of the vehicle.

According to another non-limiting embodiment, this strategy can also be downloaded into a memory of the control device included in the engine control ECU.

FIG. 2 shows a diagram depicting safety and prior conditions managed by the control device of the reversible electrical machine making it possible to implement the “Stop and Go” functionality.

As can be seen in FIG. 2, two different types of condition are taken into account:
the first, which are called safety conditions hereinafter, are tested before and during any starting phase and can prevent or interrupt the process for reasons of safety if they are no longer satisfied following a negative test.

The second conditions, referred to as prior to starting, are tested only before a starting phase, that is to say before the sending of the starting instruction, and may prevent its execution in the case of a negative test, but no longer have any influence once the instruction has been given.

It should be noted that a starting phase is determined in the following manner:
by a starting instruction that defines the beginning of a starting phase,
by a true “engine started condition”, which defines the end of a starting phase, the said condition being that the speed of the thermal engine has reached a given speed for a given time, preferably 700 revolutions per minute for at least 200 milliseconds.

Concerning the prior conditions, the invention proposes, according to a non-limiting embodiment, an advantageous provision according to which, after a first positive test, maintaining the validity of one or more of these conditions for a given period.

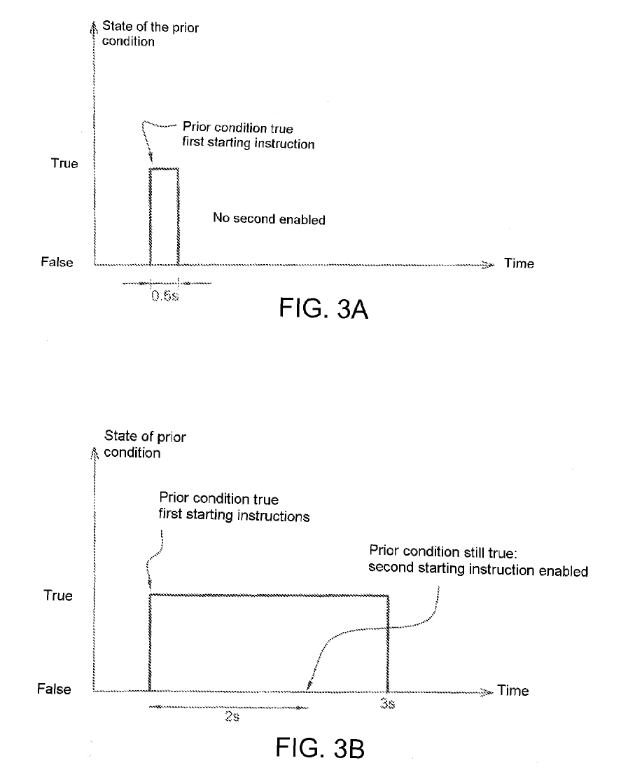

One advantage of this operating mode appears in the case where starting does not succeed as a result of poor control of the fuel injection or lack of torque supplied by the alternator/starter, or if the rotor is locked for example. Thus, for example, when a second starting instruction is implemented, this second instruction will be effected only if the prior conditions are still true, in accordance with the general provisions of the invention. There will therefore be two possibilities for each prior condition: ensuring that it is true for only a short instant (0.5 seconds), as shown by the diagram in FIG. 3a, and in this case a second starting will not be possible, or ensuring that it is true for a longer validity period, 3 seconds for example, in order to enable the second instruction, as indicated on the diagram on FIG. 3b, the duration period thus being able to vary according to the number of consecutive instructions that it is wished to enable.

It should be noted that two types of starting are taken into consideration in the context of the invention: first starts, or conventional cold starts, and restarting after having run (engine hot) and after a stop phase following the implementation of the “Stop and Go” functioning or after having stalled.

The safety and prior conditions that have just been presented may of course vary depending on whether a first starting or a restarting is envisaged.

Thus, according to non-limiting embodiments, where it is a case of a first starting:
a safety condition is to have the on-board system of the vehicle powered, that is to say the ignition key of the vehicle in the ON “after contact” position, which corresponds to the first position of the ignition key after introduction of the key into the barrel, and the drive chain open, that is to say the gear lever in the neutral position or the clutch pedal completely pressed. It should be noted that, when there exists a possibility of a so-called hands-free starting, that is to say by means of a badge for example, it is necessary in this case for the badge to be introduced into the slot provided for this purpose for identification;
another safety condition is a certain period that must have elapsed between two consecutive starting instructions, this period being able to vary from one second to several tens of seconds, according to the number of instructions implemented for example in the previous minute. This condition is necessary in order to limit the risks of overheating of the reversible electrical machine or of the associated electronics.

Still in the context of a first starting, a prior condition envisaged by the invention is a minimum duration of a starting request, for example a request by the driver using the ignition key in the starting position for at least 100 milliseconds. It is thus ensured that the driver actually wishes to start.

In the case of a hands-free starting, a prior condition envisaged is the fact that the driver presses on the starter button provided for this purpose.

In addition, according to non-limiting embodiments, for a restarting request:
safety conditions provided for by the invention are, taken separately or in combination,

a minimum period between two consecutive restart instructions, on the same terms as those disclosed above with reference to the first starts,

the closed position of the vehicle bonnet, in order to prevent restarting of the thermal engine carried out in an unwanted manner while a person is working on the engine, with the bonnet open. It should be noted that, preferentially, this second safety condition is however invalidated (it is no longer taken into account) if the driver actuates his ignition key (key in the starting position START) or uses his hands-free badge and presses the starter button provided for this purpose.

Naturally, in this case, it is also necessary for the on-board system to be powered in the same way as that disclosed above with reference to the first start.
Concerning the conditions prior to restarting, three major categories can be distinguished, namely conditions determined by at least one intentional action of the driver, conditions determined by at least one unintentional action of the driver, and conditions determined without action by the driver.

Intentional actions of the driver are, according to non-limiting embodiments:
action on the ignition key of the vehicle on the part of the user (key in starting position START) for a given minimum period (preferably at least 100 ms),
action on a means of activating/deactivating the starting control by the electrical machine. In a non-limiting example, this means is a knob on the vehicle dashboard for inhibiting the “Stop and Go” functionality,
action on a clutch pedal of the vehicle (pressing by more than 90%),
or action on an accelerator pedal of the vehicle (pressing by more than 10%).

Unintentional actions of the driver are, according a non-limiting embodiment:
opening of the driver's door, in order to prevent the driver leaving the vehicle believing the engine is cut off while it is in a stop phase.

It should be noted that a stop phase is determined by:
a stop instruction sent to a control unit of the thermal engine which defines the beginning of the stop phase, and
a thermal engine speed below a certain number of revolutions per minute which defines that the engine is stopped.

It will be understood that unintentional action by the driver means an action by the driver by means of which the said driver does not explicitly wish to request starting (including restarting) of the thermal engine of his vehicle.

The prior restarting conditions involving no action by the driver are, according to non-limiting embodiments, taken separately or in combination:
detection of the speed of the vehicle above a given value, 6 km/h for example, this condition being useful if the vehicle is situated on a slope and is travelling forward by itself,
a restart request on the part of the battery monitoring system: if the state of charge of the battery degrades too much during a stop phase, the vehicle must restart before the battery is again in a position to supply the necessary energy for restarting and for the vehicle consumers,
a restart request relating to the vehicle braking system, for example if there is a loss of braking assistance due to a leak of brake fluid; restarting the thermal engine makes it possible to supply the braking system in order to have the power necessary for correctly braking where necessary, and
a restart request for the purpose of ensuring the comfort of the driver in relation to the vehicle air-conditioning system, this system not being able to function if the thermal engine is stopped.

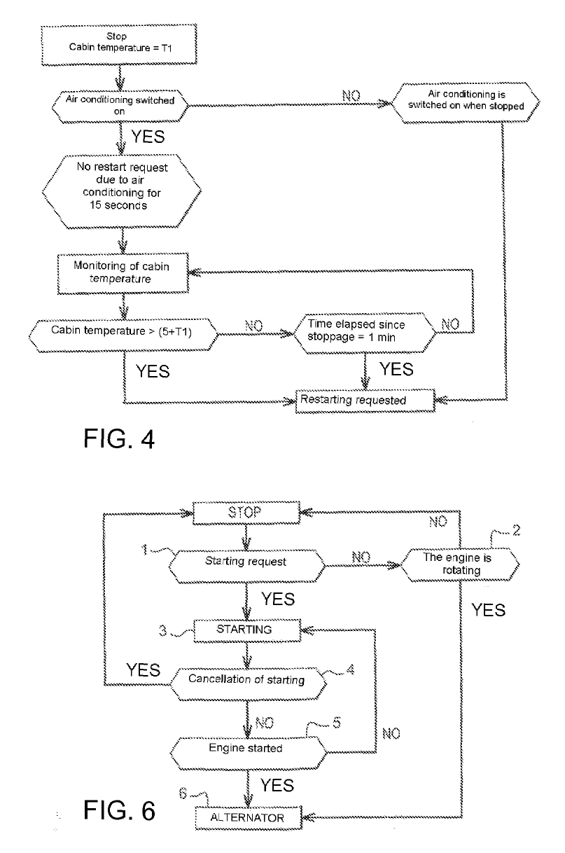

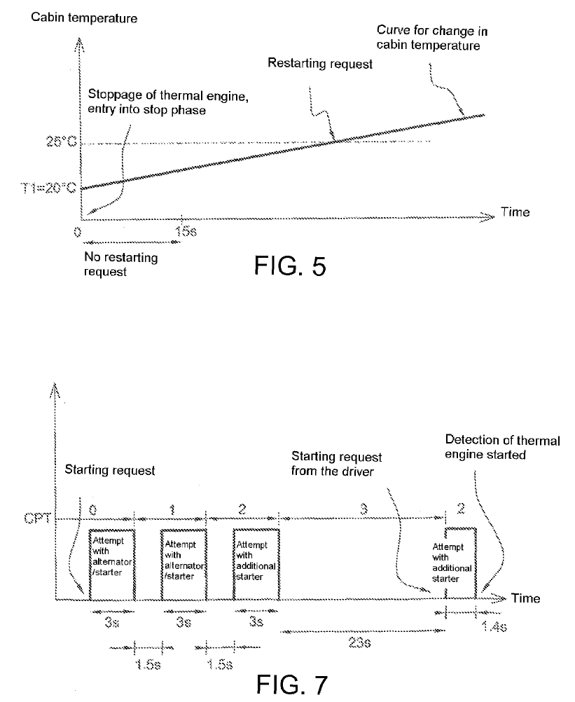

A control diagram for the prior conditions relating to the air-conditioning system and a corresponding timing diagram are given in FIGS. 4 and 5 according to a preferential embodiment.

In this example, a restart request is made if the driver switches on the air conditioning during the stop phase when it was switched off when stopped; it can in fact be thought that, if this action is performed, the driver wishes the air conditioning to be operational immediately.

If the air conditioning was switched off when stopped, any restart request sent by the air-conditioning system (independently therefore of any action by the driver) is inhibited for 15 seconds. This avoids surprising the user. This is because stopping and starting the thermal engine too quickly is avoided.

In addition, according to the type of air-conditioning system, the following specific prior restart conditions are provided in a non-limiting embodiment.

In the case of an air-conditioning system comprising a sensor disposed at the outlet from an evaporator of the air-conditioning system, the said evaporator making it possible to cool the air, and the said sensor making it possible to sense the air temperature blown outside the said evaporator, if the temperature of the said air is greater than a given value, preferably 7 degrees Celsius, a restart request is initiated.

In the case of an air-conditioning system comprising a car cabin sensor, if the temperature increases by more than 5 degrees Celsius with respect to the temperature T1 at the time of stopping, a restart request is initiated. As indicated in the example in FIG. 5, restarting is prevented for 15 seconds whatever the cabin temperature, and then a restart request is initiated when the cabin temperature is above 25 degrees, the temperature T1 at the time of stopping being 20 degrees.

In addition, if the air conditioning was switched on before the stop phase, restarting is automatically requested, whatever the type of air conditioning system, at the end of a given stop period, one minute for example. Preferentially, the stop period is dependent on the external temperature, and the said period is thus applied according to a look-up table. It can in fact be assumed that the driver wishes to have access to air conditioning even if the temperature of the cabin or of the air blown out has not increased too much.

After having established the various starting conditions tested by the method of controlling the electrical machine according to the invention, it is necessary now to present the various operating modes of the alternator/starter at the time of a starting request, these operating modes also being managed by the control method that is the object of the invention.

Referring now to FIG. 6, it can be seen that three operating modes are considered: “STOP” mode, “STARTING” mode, and “ALTERNATOR” mode.
In “STOP” mode, with the thermal engine stopped, no specific action is performed,
in “STARTING” mode, the alternator/starter is used as a rotor for starting the thermal engine, and
in “ALTERNATOR” mode, the alternator/starter is used as a generator and supplies energy to the vehicle.

From a stop phase “STOP mode”, the following steps are performed:

In a first step 1), all the safety and prior conditions are verified as disclosed above. If they are all verified, there is then a “starting request”.

In a second step 2), if there is no starting request, it is checked whether or not the thermal engine is rotating. The condition “the engine is rotating” is true if the thermal engine reaches a sufficient speed during a sufficient time; for example, if its speed has remained above 500 revolutions per minute for at least two seconds. The time of two seconds makes it possible to have no doubt about the starting. The starting request by the alternator/starter is then not executed.

This transition is necessary for managing the startings carried out without explicit instruction to the alternator/starter, for example starting by means of the traditional convention starter, or starting on a slope. In these cases, the thermal engine has started all alone without being managed by the alternator/starter. It should be noted that, when the engine rotates, “ALTERNATOR” mode is passed to as indicated at step 6), as if the alternator/starter had itself given the instruction to go into this mode.

In a third step 3), corresponding to the “STARTING” step: a starting instruction is initiated.

In the case of a first starting, in a non-limiting embodiment, the instruction is sent to the alternator/starter if the temperature of the thermal engine is above a given value, for example 0 degrees Celsius, and if the “Stop and Go” functionality is enabled by the driver by means of a knob provided for this purpose. In the contrary case, the instruction is sent to the additional conventional starter if available.

On the other hand, in the case of a restarting, the instruction is preferably always sent to the alternator/starter except in the case of a problem as described in detail below. At this moment, the rotor of the electrical machine is set in rotation, which will make it possible to start the thermal engine.

In a fourth step 4), a test is carried out to determine whether there is a cancellation of starting. A “cancellation of starting” is obtained, for example, if the clutch pedal is released before the engine has truly started or in the event of prevention of starting by the alternator/starter, as will be seen in detail below in the description on the occasion of the fitting of a counter CPT. If there is a cancellation of starting, the stop phase “STOP” is resumed.

In the contrary case, in a fifth step 5), it is checked whether or not the engine has started. The condition “engine started” is true if the thermal engine reaches a sufficient speed for a sufficient length of time; for example, if its speed has remained above 700 revolutions per minute for at least 200 milliseconds. It should be noted that the speed of the thermal engine is in general equal to one third of the speed of the alternator/starter.

It should also be noted that it is advantageous to monitor the speed of the thermal engine rather than that of the alternator/starter in order to be free of any possible failures of the belt connecting the thermal engine to the alternator/starter. This is because, if the belt breaks or slips, the thermal engine is no longer driven whilst the alternator starter could continue to rotate “in a vacuum”.

If the “motor started” condition is true, the sixth step 6) is passed to, and the alternator/starter is in ALTERNATOR mode again as indicated in FIG. 6.

In the contrary case, if, after three seconds after the sending of a starting instruction, the “motor started” condition is not true, or if a fault is immediately detected (rotor locked, overheating of the electronics or of the alternator/starter, poor establishment of the current in the rotor, a system voltage too low or too high, etc), it is considered that the starting has failed and the third step 3) of “STARTING” is returned to in order once again to attempt to effect a restarting.

However, in order to avoid any risk of overheating of the electrical machine and in particular of its management unit 19, the control method according to the invention provides a mechanism for managing the number of starting instructions sent is provided according to a non-limiting embodiment.

After each starting (including a first starting), incorrect or not, a counter CPT is incremented. According to the value of this counter, the starting will not be managed in the same way: beyond a maximum value, any starting instruction by the alternator/starter is prevented. In the following example this maximum value is taken to be equal to 2.
If the counter is equal to 0 (no starting instruction initiated up to now), the starting is effected by means of the alternator/starter with parameters that aim to minimise the starting time, for example with a rotor premagnetisation time chosen that tends to be as short as possible, that is to say the time during which the maximum current is sent into the rotor to magnetise it and before being able to start effectively.
If the counter is equal to 1 (a starting instruction already initiated), it is attempted to start still with the alternator/starter, but certain parameters may be modified in order to optimise the chances of success, even if it means increasing the duration of starting. It is possible for example to increase the rotor premagnetisation time in order to ensure that the maximum torque is obtained.
If the counter is equal to 2 (two instructions already initiated), it is attempted to start using another means, for example the additional conventional starter, if available. This is because it is possible that, under certain conditions unfavourable to the alternator/starter, engine cold for example, the additional starter is more appropriate for starting the thermal engine. It should be noted that the starting instruction is sent to the conventional starter 5 by the management unit 9 for example by means of a relay R between the management unit 9 and the convention starter 5 as indicated in FIG. 1.

Moreover, whatever the value of the counter, an interval of time is preferably waited, for example at least 1.5 seconds between two starting instructions, in order to avoid electronic overheating at the alternator/starter.

After the last instruction, any new starting instruction is prevented, namely the “cancellation of starting” condition of FIG. 6 becomes true and therefore the stop phase “STOP” is returned to as indicated in FIG. 6.

Finally, according to a preferential embodiment, the counter CPT is routinely decremented by one unit per given interval of time, for example every 20 seconds (“cancellation of starting” condition false). It is thus possible to attempt a starting (including restarting) again after 20 seconds. Thus, for example, this may apply when a starting has failed by means of the conventional starter. In this case, at the end of 20 seconds after the last starting attempt (CPT=3) it is possible to reattempt starting with the starter and at the end of 40 seconds with the alternator/starter.

This mechanism is advantageous, in particular in the case of failed starting, in order to minimise the impact on the driver: as long as the starting request is present, that is to say for example as long as the air conditioning has sent a starting request and all the safety and prior conditions necessary are true, it is possible to concatenate the instructions automatically in a manner that is transparent for the driver.

In addition, in a non-limiting embodiment, in the case of three consecutive failures, and therefore a pause of at least 20 seconds before any other sending of a starting instruction, it can be envisaged that another instruction be possible only after an explicit request from the driver according to an intentional action as defined previously, for example by an action on the key or on one of the pedals, etc, so as to not start in an impromptu manner while the driver is not prepared for it, and this although there is a “starting request”, that is to say all the safety and prior conditions are true.

The timing diagram in FIG. 7 shows the example of three consecutive starting instructions that have failed because of a period of 3 seconds that has elapsed before the speed of the thermal engine has reached the required 700 revolutions per minute, followed by a pause of 23 seconds, and another attempt after the explicit action by the driver.

The pause having only been for 23 seconds, the counter has been decremented only once; it is therefore equal to 2 at the time of the last starting instruction, the said starting therefore being performed by means of the additional starter.

Finally, in a sixth step 6), when the engine is started, ALTERNATOR mode is passed to.

Naturally in the context of the invention, in order to have access to certain information such as the cabin temperature, the position of the clutch, brake and accelerator pedals, the gearbox position, the ignition key position, etc, sensors are used.

1. A control method of controlling a rotary electrical machine for a motor vehicle, said machine being intended to function in starter mode for starting a thermal engine of the said vehicle, wherein said method comprises the steps of:
testing safety conditions before and during any starting phase, and
testing prior-to-starting conditions before said starting phase.

2. The control method according to claim 1, wherein the rotary electrical machine is intended to function in generator mode in order to supply an on-board system of said motor vehicle.

3. The control method according to claim 1, and further comprising steps of:
in the case of a negative test on the safety conditions, preventing or interrupting at any time an execution of said starting phase, and
in the case of a negative test on the prior-to-starting conditions, preventing an execution of said starting phase.

4. The control method according to claim 1, and further comprising a step of:
in the case of a positive test, keeping the prior-to-starting conditions valid for a given validity period.

5. The control method according to claim 1, and further comprising a step of interrupting the starting phase in the case of loss of validity of the prior-to-starting conditions.

6. The control method according to claim 1, wherein when the starting is a first starting, a safety condition is a minimum period separating two consecutive starting instructions.

7. The control method according to claim 1, wherein when the starting is a first starting, a condition prior to starting is a minimum duration of an action on an ignition key of the vehicle.

8. The control method according to claim 1, wherein when the starting is a restarting, said safety conditions are, taken separately or in combination, a minimum period between two consecutive restarting instructions and a closed position of the vehicle bonnet.

9. The control method according to claim 8, wherein said method further comprises the step of invalidating said safety condition of the closed position of the vehicle bonnet in the case of an action on an ignition key of the vehicle.

10. The control method according to claim 1, wherein when the starting is a restarting, said prior-to-starting conditions are determined by at least one intentional action of the vehicle driver.

11. The control method according to claim 10, wherein said at least one intentional action is an action on an ignition key of the vehicle for a given minimum period, an action on a means of activating/deactivating the starting control by the electrical machine, or an action on the clutch pedal of the vehicle or an action on an accelerator pedal of the vehicle.

12. The control method according to claim 1, wherein when the starting is a restarting, said prior-to-starting conditions are determined by at least one involuntary action by the vehicle driver.

13. The control method according to claim 12, wherein said involuntary action is an opening of the driver's door.

14. The control method according to claim 1, wherein when the starting is a restarting, said prior-to-starting conditions are determined without action by the driver.

15. The control method according to claim 14, wherein said prior conditions are, taken separately or in combination, a detection of the speed of the vehicle above a given value, a restart request coming from a vehicle battery monitoring system, a restart request that is a function of a vehicle air-conditioning system, and a restart request that is a function of a vehicle braking system.

16. The control method according to claim 15, wherein said method further comprises the step of sending a request to restart the thermal engine if the air-conditioning system is started up during a stop phase of the thermal engine, when it is switched off at rest.

17. The control method according to claim 15, wherein said method further comprises the step of preventing the sending of a request to restart the thermal engine for a given period if the air-conditioning system was in operation when the thermal engine was stopped.

18. The control method according to claim 17, wherein said air-conditioning system comprises an air temperature sensor at the discharge from an evaporator of the air-conditioning system, and said method further comprises the step of sending a request to restart the thermal engine if the temperature of said air at the discharge from the evaporator is above a given value.

19. The control method according to claim 17, wherein said method further comprises the step of sending a request to restart the thermal engine if the temperature of the vehicle cabin increases by a given value after a stoppage of the thermal engine.

20. The control method according to claim 17, wherein said method further comprises the step of sending a request to restart the thermal engine at the end of a given period of stoppage.

21. The control method according to claim 1, wherein said method further comprises a starting instruction that is not executed if the thermal engine is already started.

22. The control method according to claim 21, wherein said method further comprises the step of configuring said rotary electrical machine in generator mode if the thermal engine is already started.

23. The control method according to claim 1, wherein said method further comprises the steps of:
counting starting instructions by means of a counter;
incrementing said counter by one unit at each starting instruction up to a maximum value beyond which any starting instruction is prevented; and
and decrementing said counter by one unit per given time interval.

24. The control method according to claim 23, wherein two consecutive starting instructions are separated by a given interval of time.

25. The control method according to claim 23, wherein said method further comprises the step of:
transmitting the starting instruction to the rotary electrical machine when the counter is below the excluded maximum value.

26. The control method according to claim 23, wherein said method further comprises the step of:
transmitting the starting instruction to an additional starter when the counter has reached the maximum value.

27. A device for controlling a rotary electrical machine for a motor vehicle, said rotary electrical machine being intended to function in starter mode in order to start a thermal engine of said vehicle, said device comprising:
first means for testing safety conditions, before and during any starting phase, and
second means for testing prior-to-starting conditions before said starting phase.

28. The control device according to claim 27, wherein:
the first means is also able to prevent and interrupt an execution of said starting phase at any moment in the event of a negative test on the safety conditions, and
the said second means is also able to prevent execution of the starting phase in the event of a negative test on the prior conditions.

29. A reversible rotary electrical machine comprising a device for implementing the method according to claim 1.
